(19) United States
(12) Patent Application Publication
(10) Pub. No.: US 2008/0194334 A1
(43) Pub. Date: Aug. 14, 2008

(54) System and method for online games

(75) Inventors: Chon Fong Kuok, San Cheong (MO); Malaquias Man Kit Lo, Ka Fai (MO)

Correspondence Address: Akin Gump LLP - Silicon Valley, 3000 El Camino Real, Two Palo Alto Square, Suite 400, Palo Alto, CA, 94306, US

(73) Assignee: ENTERTASIA TECHNOLOGY CO., LTD.

(21) Appl. No.: 12/011,841

(22) Filed: Jan. 29, 2008

Related U.S. Application Data
(60) Provisional application No. 60/898,321, filed on Jan. 29, 2007.

(51) Int. Cl. A63F 13/00

(52) U.S. Cl. 463/42

(57) ABSTRACT

Disclosed herein are systems and a machine-readable medium embodying instructions for playing a card game from one or more remote locations. The system comprises a host configured to provide online game services and game-play information corresponding to at least one real-time game, the information corresponding to each real-time game includes audio or video programming information on a plurality of channels, host-specific information and participant-specific information. The disclosed systems and machine-readable mediums may also allow players to select a channel from the plurality of channels of audio or video programming. Also disclosed are additional features to facilitate and/or enhance game play online.

### FIELD OF THE INVENTION

The present invention relates in general to systems and methods for online games.

### BACKGROUND

Online gaming systems provide for an interactive platform for online gaming participants where websites utilizing streaming audio and video applications have revolutionized the participant's level of real-time experience and interaction between the host and the participant or amongst many different participants. Online game operators currently offer a number of casino games online, such as poker, blackjack, and baccarat. The ability to play games online is attractive to players because it allows them to play casino games without having to go to a real land-based casino, and players can play from the comfort and privacy of their own homes. From a game operator point of view, online gaming allows operators to reach players in multiple locations at the same time and to reach players that may not have easy access to a land-based casino. Online games, however, are often not as appealing because it lacks the player-player, and player-dealer interactions found at a land-based casino, and other experiences, such as the ability to actually handle cards, which are available at real tables found in land-based casinos.

Additionally, bandwidth limitations on the network have been a major drawback for real-time multiplayer online games where the presence of multiple participants on a server in given network causes latency between and among participants. While online game operators have tried to enhance the online gaming experience by introducing streaming or live video and audio applications for online games, such features have further introduced latency issues where oftentimes the server and the client are not at optimal connection levels. As such, online games performing real time interactivity, including streaming audio and video applications, are restricted.

There is a need of a system that provides enhanced features that encourage more interaction and bring enhanced features to online game players, and a system that addresses bandwidth limitations on the network relating to online games without disrupting game play such that user interactions can be implemented.

### BRIEF SUMMARY OF THE INVENTION

Systems consistent with the present invention can be used for playing a card game from one or more remote locations. The system comprises a host configured to provide online game services and game-play information corresponding to at least one real-time game, the information corresponding to each real-time game includes audio or video programming information on a plurality of channels, host-specific information and participant-specific information; a host interface coupled with the host and a network, the host interface configured to communicate with at least one player-located device each associated with a participant and to receive instructions from the participant, each player-located device configured to receive the audio or video programming information on one of a plurality of channels, host-specific information, and participant-specific information; a first host device for verifying an identity associated with a player; a second host device for providing the player with a recent history associated with the host through the host interface; and a storage device coupled with the host device and configured to store game play information.

The host device and player-located device can be computers where the host computer connected to a network, and one or more remote computers connected to the host computer through the network, each remote computer having software that is capable of providing an environment and interface for playing the card game on the remote computer. The host computer and remote computers may be connected via wire or wirelessly, for example, through a local area network, or through the internet. The host computer may comprise one or more computers or servers, for example, maintained by the game operator or casino operator. The system and method for playing a card game may further comprise one or more features to facilitate and/or enhance game play, as described in the embodiments below.

Additionally, the present invention also includes a machine-readable medium embodying instructions for playing a game online, which, when executed by a machine operated by a participant, cause the machine to establish a connection between the machine to at least one host through a network; exchange with the at least one host, game-play information corresponding to at least one real-time game, the information corresponding to the at least one real-time game including audio or video programming information on at least one of a plurality of channels, host-specific information, and participant-specific information; provide the participant a choice of selecting one channel from the at least one of a plurality of channels; display game play information received from the at least one host, including the audio or video programming information selected from the at least one of a plurality of channels.

### BRIEF DESCRIPTION OF THE DRAWINGS

FIG. 1 displays an embodiment of the present invention illustrating audio and video programming integrated with the user interface.

FIG. 2 displays another embodiment where a system may provide multiple gaming experiences simultaneously with audio/video programming.

FIG. 3 is an exemplary embodiment where the audio/video application and the multiple gaming experience is combined with the option to switch or transfer into another game when possible.

FIGS. 4A-C illustrate an embodiment implementing real-time peeking.

FIGS. 5A-C illustrate another example providing real-time multiple player experience.

FIGS. 6A-B illustrate another embodiment providing real-time, multiplayer experience with a visual three-dimensional, animated table.

FIGS. 7A-B illustrate yet another example where the system may include a feature offering real betting chips experience.

FIGS. 8A-B illustrate another embodiment where different languages and various expression icons are used.

FIGS. 9A-C illustrate an exemplary embodiment where the system may implement multiple video re-broadcasting technique to overcome streaming errors.

FIGS. 10A-F illustrate an example of a system that may include result tracing indicators.

### DETAILED DESCRIPTION

Reference will now be made in detail to the present embodiments of the invention, examples of which are illustrated in the accompanying drawings.

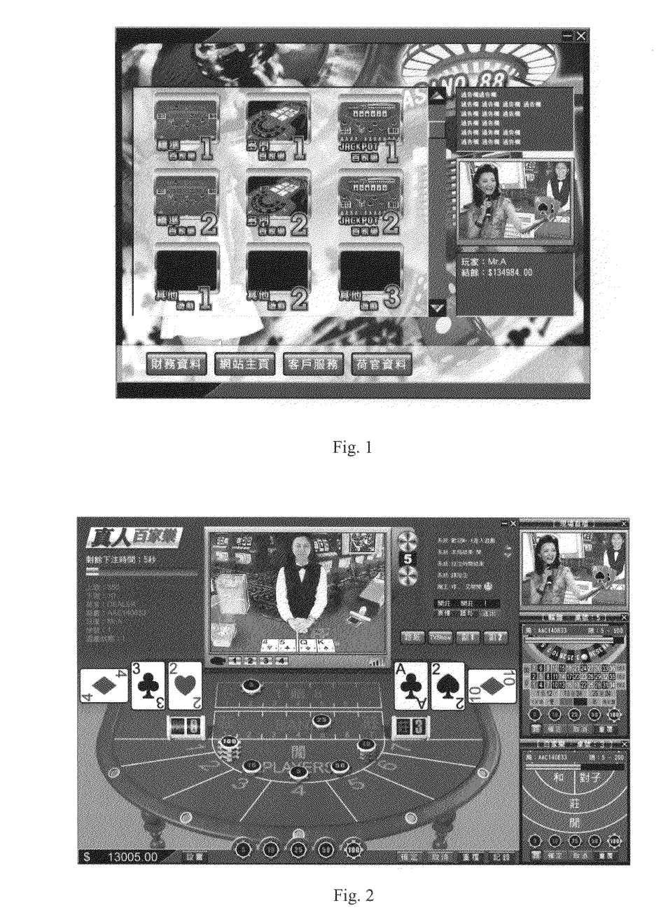

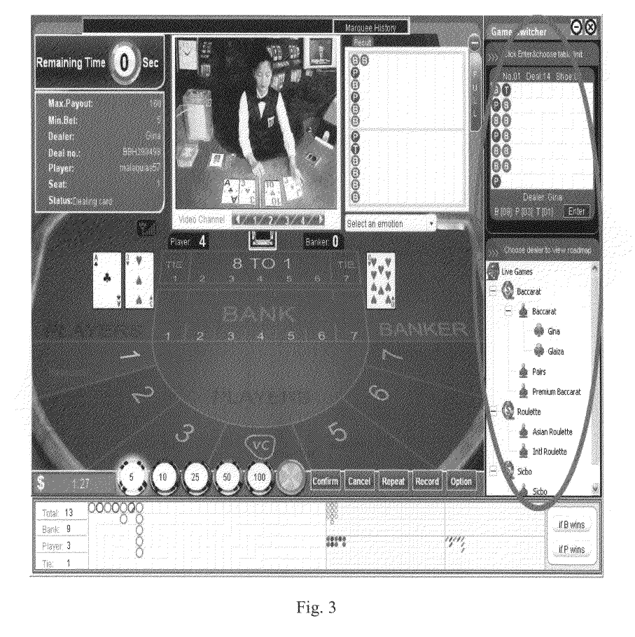

In one example as shown in FIGS. 1 and 2, a system may include a ‘Webcast’ of audio and/or video programming integrated with the user interface. For example, players can enjoy audio and/or video entertainment programs while playing a card game. The webcast may comprise live broadcasts with hosts, much like a radio station broadcast, or comprise pre-recorded programming. The webcast may be used to create a friendly and/or enjoyable playing experience, and may result in interactive experience for players. A participant may include any user or player connected to the host for the purpose of linking onto the games the hosts offer.

In another example, the card game played using the system may include progressive and non-progressive jackpots where a jackpot bonus will be given to players when certain conditions are met for each hand of cards in the card game. For example, in the game of baccarat, if players bet an extra “unit,” the system can generate 4-6 animated cards to the players before the deal distributes the actual cards in play for that game. If the animated cards match the real cards in a certain combination, players will be rewarded with extra incentives or a jackpot bonus.

FIG. 2 illustrates an exemplary system that may provide multiple games playing experience where one player can play in two or more separate card games held by the operator or casino at one time on the user interface via split screens and/or multiple windows.

Additionally, in another embodiment, while playing one game, the player may have the option to switch or transfer into another game whenever possible. Via a split screen and/or a multiple windows, players can be informed of a list of available games and its corresponding history. In the case of the card game Baccarat, having the option to view other available games and its corresponding history is advantageous as it provides the player an idea in advance on whether the result pattern of a particular game is favorable. For example, FIG. 3 shows the game switcher module as added into the game program on the right hand side of the user interface, and module has two parts. The bottom window is the game list which shows all the available games and the corresponding dealer name who serves each game table. The top window is the display window which shows the corresponding game table's result history so players can have an idea in advance on whether the result pattern of a particular game table is favoring for him to play.

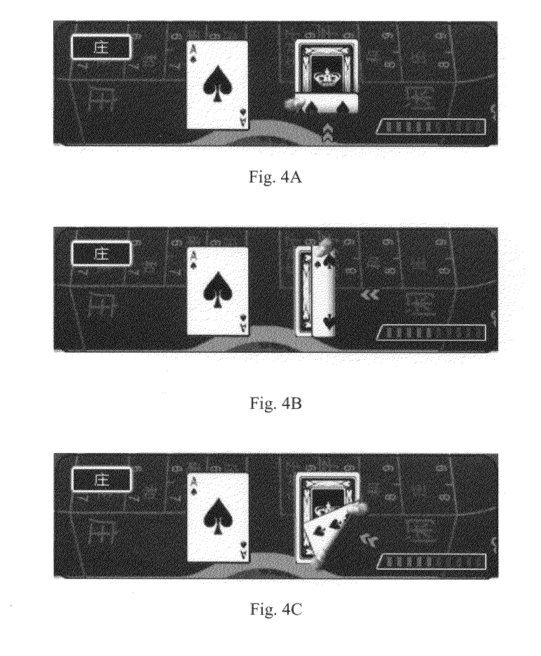

FIGS. 4A to 4C show yet another example, where the card game being played on the system may offer real card peeking experience where a designated player is allowed to virtually handle a card being played and control when a card is flipped to reveal the card-value. For example, in a Baccarat game, the player who bets the most on a particular result, such as “dealer” can touch and flip the cards dealt to the “dealer.” The same privilege is given to the player who bets the most on the “player.” The system disclosed herein may implement this experience by allowing a designated player to virtually flip, turn, and peek at one or more cards in play as shown by the different views of the card in FIGS. 4A-4C.

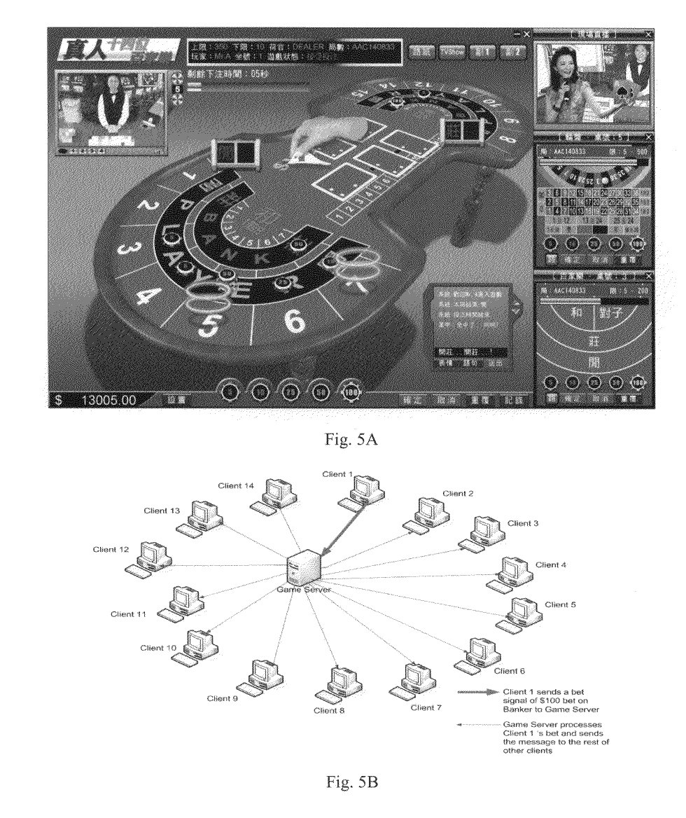

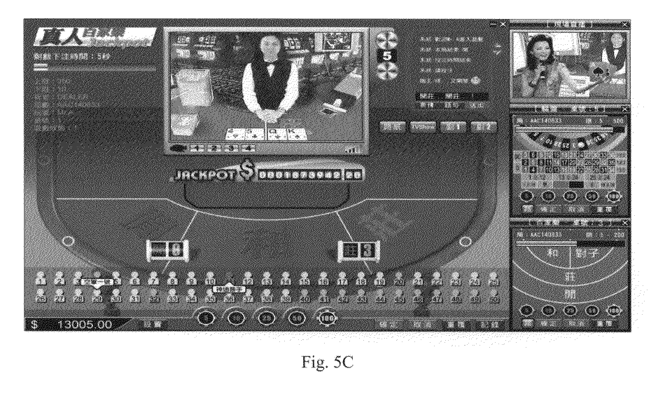

In another example, the system may accommodate multiple seat tables in the user interface that allows multiple players to play at the same table and allows each player to interact with other players on the table and watch all the playing action happening in real time. FIG. 5A, for example, shows at any table, 7 to 14 players can be “seated” at the table and each player will be able to interact and view the bets of the other players on their respective user interfaces. FIG. 5B shows how the system may include a server or game server with multiple clients corresponding to players interacting through an interface like the one depicted in FIG. 5A.

In yet another example as portrayed in FIG. 5C, the system may allow large group betting wherein 14 or more players can bet on the same table. For example, different sizes of large groups, such as 20, 30, 50, and 100 people can play on the same table.

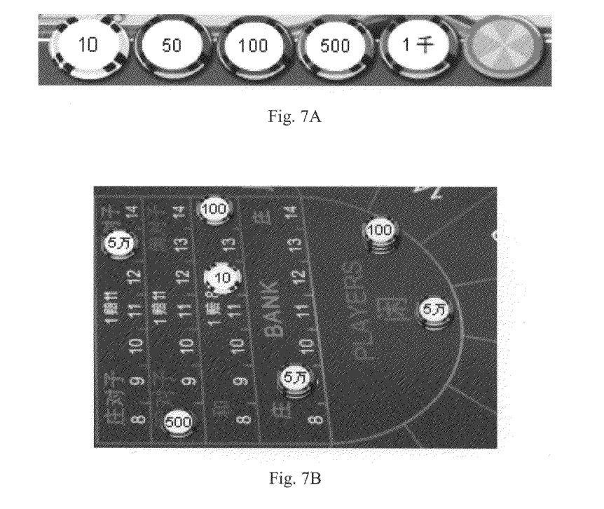

In yet another example, the system may have the ability to use and display multiple currencies, multiple chip denominations and types, and vouchers. In other words, the system may offer the flexibility to handle multiple types of currencies, chips, and vouchers, and operate and display information accordingly, such as bet amount and account balance in terms of the different currencies, chips, and vouchers. FIGS. 7A and 7B show such examples.

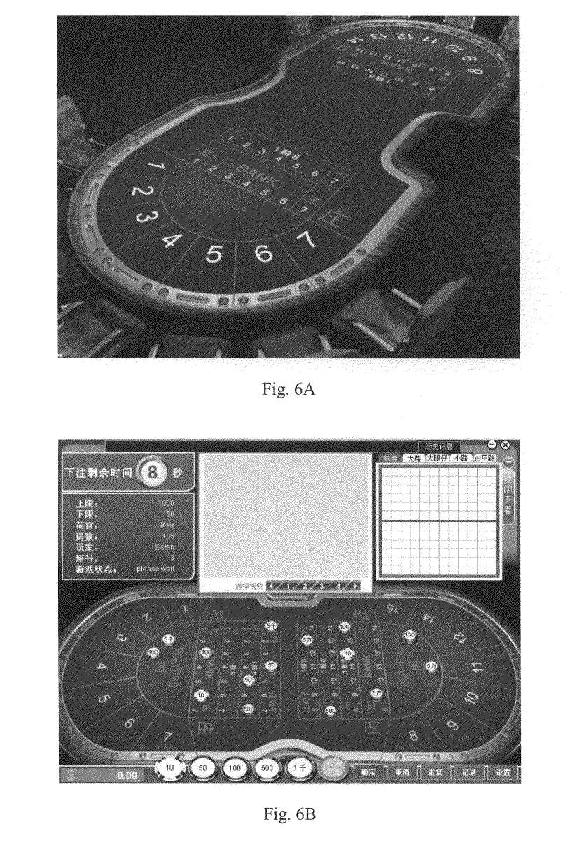

In another example depicted in FIGS. 6A and 6B, the user interface of a system may include realistic table design. For example, it may be a visual three dimensional animated table design that simulates a gaming table seen at a casino. Such a table design provides at least the benefit of simulating a real playing experience with the realistic placement of bets and cards.

In yet another example, FIGS. 7A and 7B portray a system that may include a feature offering real betting chips experience where players can place a bet and see chips stacking up corresponding to the amount being bet just like real betting on a table. This feature may involve the use of different color chips representing different denominations.

In another example, a system may include a junket management system that provides a system for managing junkets that work with operators of the card game. For example, in this system, players can be categorized in different junket groups of which they belong. Junket operators can use this feature to easily determine player activities, betting volume, and results. The junket management aspect of the system may keep track of and manage all the above data, as well as other relevant data, such as player turnover volume, junket chips turning volume, or profit/loss sharing percentages, and calculate the junket commission accordingly.

In another example, the system may include a multiple level agency expansion structure which allows operators using this feature to have the flexibility to create multiple partnerships, affiliates, and agent relationships in the system. For example, operators can setup different partnership models and/or deals, which include specified commission rebates and profit sharing percentages to a 1st tier agent and the 1st tier agent can in turn offer another deal to a 2nd tier agent, and so forth. This feature may help operators to organize and track their business in a multiple level marketing structure.

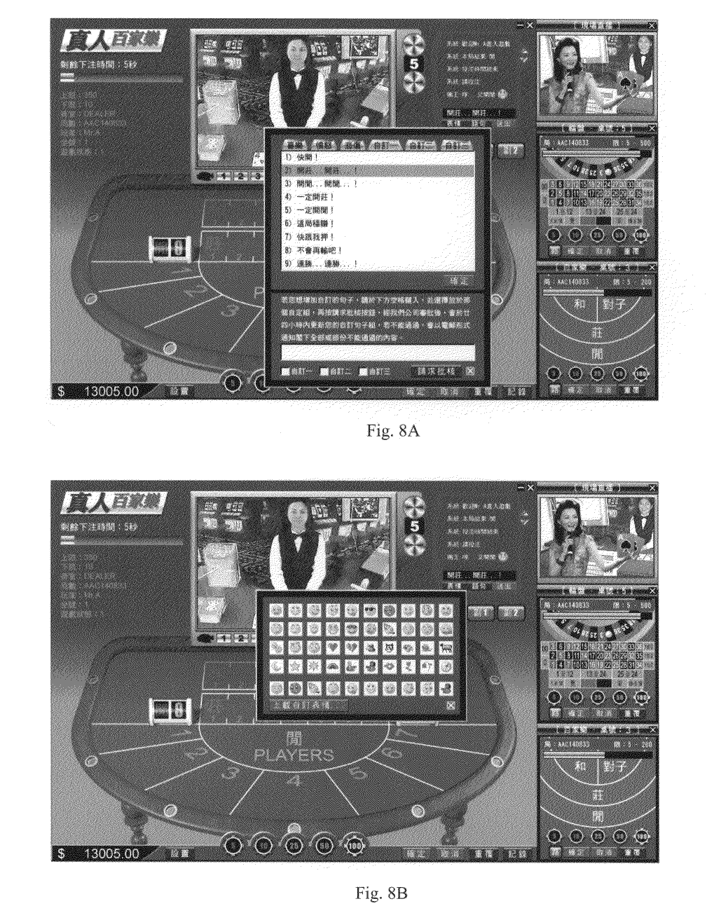

In another embodiment displayed in FIG. 8A, the system may offer different language platforms to display information and allow game play in different languages. For this feature, for example, users may choose one language from a list of supported languages to be displayed in the user interface during play. The system, as shown in FIG. 8B, may also offer customized expression icons and animations through the user interface that may be used to allow players on the same table to communicate and interact with each other with pre-programmed icons and animations on the user interface. One benefit of this feature is to allow players playing on different language platforms to communicate with each other without any language problems. For example, if you are playing on the English platform and send an expression icon or message, players playing using a Chinese platform will see your expression message in Chinese.

In another example, the system may include an agency feature, which allows players to divide their account balance into multiple sub-accounts. One use of such a feature is the ability to entertain friends. For example, a player who may have visitors and want to join the player's card game can do so without opening a completely new account. This feature allows a player to divide an account into multiple sub-accounts which friends can use to bet in their own game.

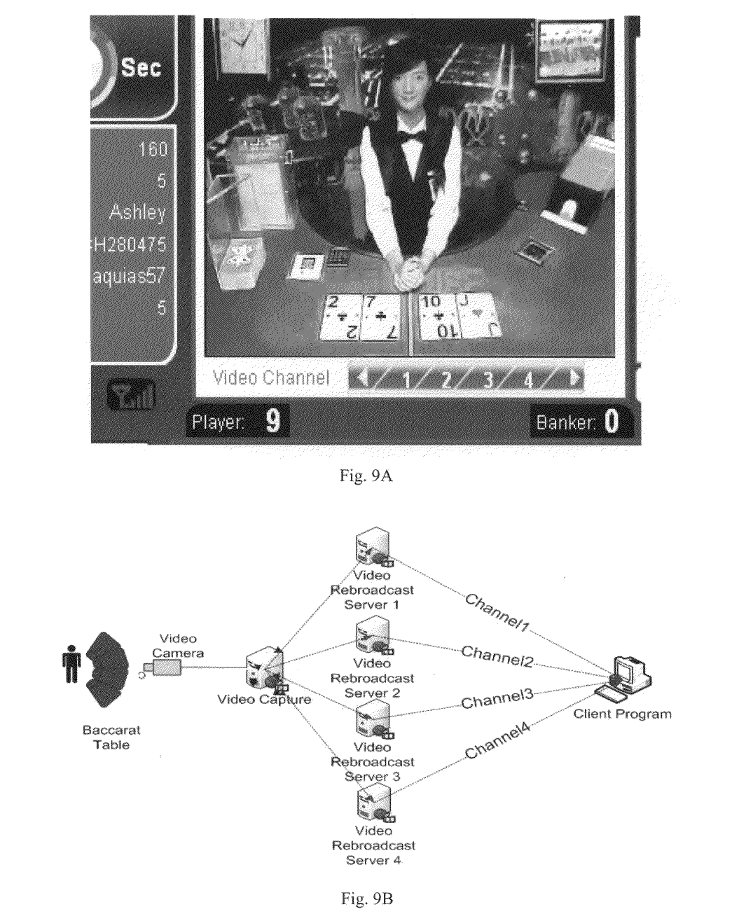

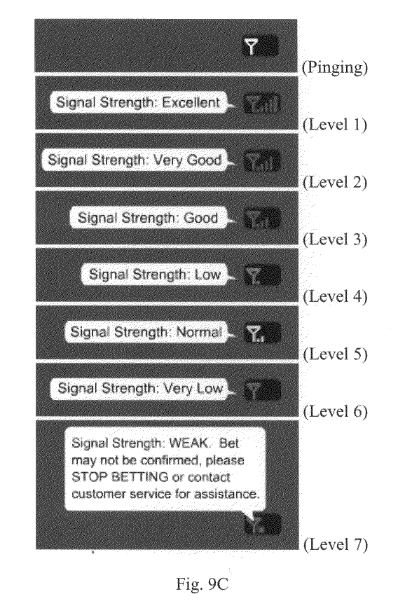

In another example, a system may implement multiple video re-broadcasting technique to overcome video streaming errors often caused by internet congestion reducing the quality of the video and game play. This example is portrayed in FIGS. 9A and 9B where the multiple video re-broadcasting feature of the system comprises the use of multiple channels that the user can choose to connect to through the user interface, each providing a video broadcast from a different location, but of the same video feed. As shown in FIG. 9B, the multiple channels are generated as images are captured by a video camera connected a video capture system, which then transmits the video to a plurality of servers, each capable of generating a channel to transmit to a client program on a user's computer. The multiple channels of varying connection may be sorted based on the corresponding response time from a Ping request from the player to the host computer. Once the sorting is complete, the channels are displayed on the player-located device, i.e., remote personal computer, at which time the player may select a channel to connect. As internet connectivity and routing status constantly varies, this manual selecting video channel helps the player to get the best video quality available.

In another example as displayed in FIGS. 9A and 9C, the system may include an internet congestion indicator and methods for determining congestion in the user interface that informs users about the quality of their internet connection or the speed of the connection, which may be affected by factors such as the number of total players currently on-line with a game operator, the distance of the host computer from the remote computer, and bandwidth of the connection between the host computer and the remote computer. The system may take such factors into consideration to determine congestion. An exemplary method of determining congestion is the use of ping on a routine basis to check the response time between the player and the host computer. The indicators may comprise, for example, the showing of multiple bars corresponding to various levels of connection, each bar representing lack of congestion such that more bars means better internet connection or less congestion. FIG. 9C shows 7 levels of connection status ranging from “Excellent” to “Weak.”

In yet another example, the system may include result tracing indicators in the user interface in order to track results or outcomes of previous plays of a card game. For example, in the game of Baccarat, FIG. 9A shows one typical indicator is called the Standard Result Indicator which records whether the “banker” or “player” hand won in previous plays of the game, or whether there was a tie. The result of each game will be recorded in sequence on a table with multiple cells. Each cell may be marked with a circle of either blue or red color, for example, where blue represents a player win, while red represents a banker win. A tie may be marked by a green tick mark in the circle of the last result. The results may be displayed on the user interface for a pre-determined period of time or plays, for example, the result tracing is refreshed after every shuffle of cards. Such indicators may help players to keep track of the past results in the shoe of cards currently playing.

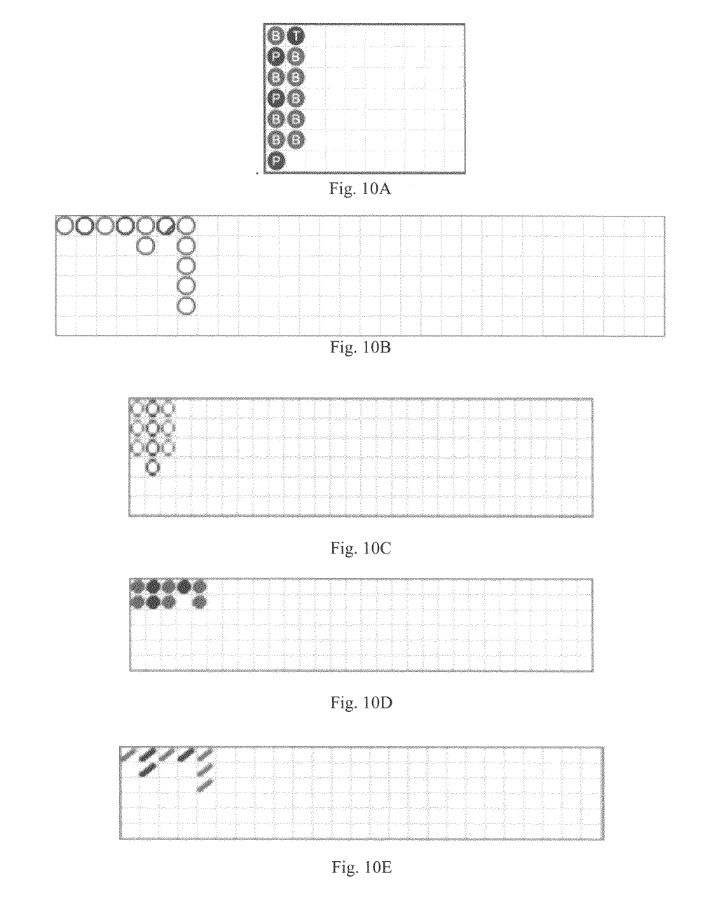

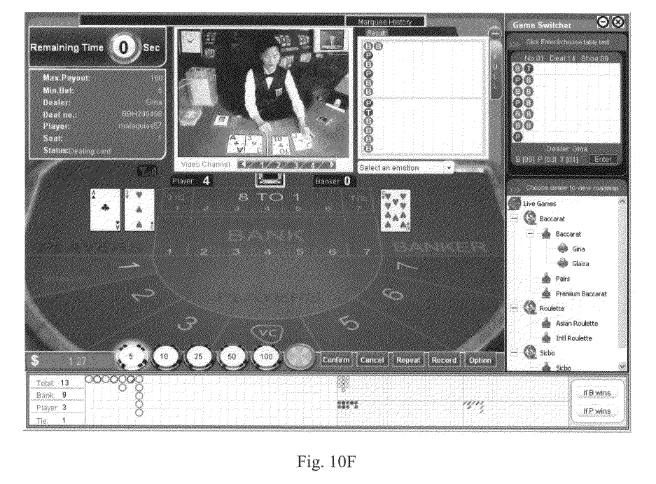

FIG. 10F displays an embodiment that may include result-tracing indicators at the bottom of the screen. Other examples of result tracing indicators for Baccarat include “Big Road (FIG. 10B),” “Big Eye Boy Road (FIG. 10C),” “Small Road (FIG. 10D),” and “Cockroach Road (FIG. 10E).” Each of these indicators track results and are well known in the field.

In yet another example of the system, the system may include in the interface on the remote computer, a real-time video feed of a live dealer allowing the player to see cards in play being dealt in real time. In this example, a television set may be displayed in the background of the live dealer. The television can be tuned to a news channel, or other well known channel to demonstrate to players that all video action is occurring in real-time and not pre-recorded.

Embodiments consistent with the present invention may be implemented in a variety of venues, such as in casinos, at stand-alone kiosk machines, and through on-line gaming operators via the internet.

Illustrational examples (Exhibit A) of game tracking methods are enclosed without limiting the scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for offering an online game, the system comprising:
a host configured to provide online game services and game-play information corresponding to at least one real-time game, the information corresponding to each real-time game includes audio or video programming information provided through at least two communication channels, host-specific information and participant-specific information;
a host interface coupled with the host and with a network, the host interface configured to communicate with at least one player-located device each associated with a participant and to receive instructions from the participant, each player-located device configured to receive the audio or video programming information through one of the at least two communication channels, host-specific information, and participant-specific information;
a first host processing device for verifying an identity associated with a player;
a second host processing device for providing the player with a recent history associated with the host through the host interface; and
a storage device coupled with the host device and configured to store game play information.

2. The system of claim 1 wherein the player-located device is a remote personal computer.

3. The system of claim 1 wherein the host provides the choice of selecting a channel from the at least two communication channels of audio or video programming information.

4. The system of claim 1 wherein the host interface is further configured to test the quality of the connection between the plurality of host devices to the player-located device.

5. The system of claim 1 wherein the online game comprises a card game having at least one of a standard wager and an additional jackpot wager.

6. The system of claim 1 wherein each remote computer is configured to have a display interface for displaying at least one window for each of the at least one real-time games.

7. The system of claim 1 wherein the online game is a card game and a designated participant may control the flipping and turning of cards in play.

8. The system of claim 1 wherein at least one of the host and the host interface is further configured to allow each participant to view bets placed by other participants and communicate with other participants.

9. The system of claim 1 wherein the host is further configured to receive participant bets in at least one of currency, chips, and vouchers.

10. The system of claim 1 wherein each player-located device is configured to display through a display interface a realistic image of a card game table.

11. The system of claim 1 wherein each player-located device is configured to display through a display interface wagers of each participant as a combination of chips of different denominations.

12. The system of claim 1 wherein the host is configured to track and categorize participant and participant activities according to junket groups, agents, and operators.

13. The system of claim 1, further comprising a remote computer interface configured to provide pre-programmed message icons that participants can send to other participants to communicate with other users.

14. The system of claim 1 wherein the system is configured to give a participant an option to divide an account balance into multiple sub-account balances.

15. The system of claim 1 wherein the audio or video programming information includes a real-time video feed of a dealer dealing cards into play.

16. The system of claim 1, further comprising a remote computer interface configured to display one or more result tracing indicators for a card game.

17. The system of claim 1 wherein the audio or video programming information includes a real-time video feed of a dealer dealing cards into play and a television set tuned to a broadcast channel placed in the same video frame.

18. A machine-readable medium embodying instructions for playing a game online, which, when executed by a machine operated by a participant, cause the machine to:
establish a connection between the machine with at least one host through a network;
exchange with the at least one host, game-play information corresponding to at least one real-time game, the information corresponding to the at least one real-time game including audio or video programming information on one of at least two communication channels, host-specific information, and participant-specific information;
provide the participant a choice of selecting one channel from the at least two channels;
display game play information received from the at least one host, including the audio or video programming information selected from the at least one of a plurality of channels.

19. The machine-readable medium of claim 18 wherein the machine is a personal computer.

20. The machine-readable medium of claim 18 wherein the game-play information further includes information about the quality of the connection between the machine and the at least one host.

21. The machine-readable medium of claim 18 further causing the machine to display the quality of the connection between the machine and the at least one host.

22. The machine-readable medium of claim 18 wherein the online game comprises a card game having at least one of a standard wager and an additional jackpot wager.

23. The machine-readable medium of claim 18 wherein each remote computer is configured to have a display interface for displaying at least one window for each of the at least one real-time games.

24. The machine-readable medium of claim 18 wherein the online game is a card game and a designated participant may control the flipping and turning of cards in play.

25. The machine-readable medium of claim 18 wherein the host and the host interface allow each participant to view bets placed by other participants and communicate with other participants.

26. The machine-readable medium of claim 18 wherein the host is configured to receive participant bets in at least one of currency, chips, and vouchers.

27. The machine-readable medium of claim 18 wherein each player-located device is configured to display through a display interface a realistic image of a card game table.

28. The machine-readable medium of claim 18 wherein each player-located device is configured to display through a display interface wagers of each participant as a combination of chips of different denominations.

29. The machine-readable medium of claim 18 wherein the host is configured to track and categorize participant and participant activities according to junket groups, agents, and operators.

30. The machine-readable medium of claim 18, further comprising a remote computer interface configured to provide pre-programmed message icons that participants can send to other participants to communicate with other users.

31. The machine-readable medium of claim 18 wherein the system is configured to give a participant an option to divide an account balance into multiple sub-account balances.

32. The machine-readable medium of claim 18 wherein the audio or video programming information includes a real-time video feed of a dealer dealing cards into play.

33. The machine-readable medium of claim 18, further comprising a remote computer interface configured to display one or more result tracing indicators for a card game.

34. The machine-readable medium of claim 18 wherein the audio or video programming information includes a real-time video feed of a dealer dealing cards into play and a television set tuned to a broadcast channel placed in the same video frame.
